(19) United States
(12) Patent Application Publication
(10) Pub. No.: US 2019/0098717 A1
(43) Pub. Date: Mar. 28, 2019

(54) BALLAST SYSTEM, LUMINAIRE, LIGHTING CONTROL SYSTEM, LIGHTING CONTROL METHOD AND NON-TRANSITORY COMPUTER READABLE MEDIUM

(71) Applicant: Panasonic Intellectual Property Management Co., Ltd., Osaka (JP)

(72) Inventors: Kenichi FUKUDA, Osaka (JP); Hirofumi KONISHI, Osaka (JP); Masashi MOTOMURA, Osaka (JP)

(21) Appl. No.: 16/138,987

(22) Filed: Sep. 22, 2018

(30) Foreign Application Priority Data
Sep. 26, 2017 (JP) 2017-185339

(51) Int. Cl. H05B 33/08; H05B 37/02

(52) U.S. Cl. CPC H05B 33/0851; H05B 37/0263; H05B 33/0866; H05B 33/0815

(57) ABSTRACT

The ballast system includes constant current circuits, the power supply circuit, signal paths, a control circuit and pull-up circuits. A junction point of resistors in each of the pull-up circuits is connected to a corresponding signal path of the signal paths.

### CROSS REFERENCE TO RELATED APPLICATION

This application claims the benefit and priority of Japanese Patent Application No. 2017-185339, filed on Sep. 26, 2017, the entire contents of which is incorporated herein by reference.

### TECHNICAL FIELD

The disclosure relates generally to a ballast system, a luminaire, a lighting control system, a lighting control method and a non-transitory computer readable medium.

### BACKGROUND ART

Document 1 (JP 2011-108799 A) discloses a light emitting device (conventional light emitting device) including a voltage step-up circuit, constant current drivers, a step-up controller configured to control the voltage step-up circuit, and light emitting element arrays.

In the conventional light emitting device, the constant current drivers are individually connected to the light emitting element arrays. The constant current drivers supply the light emitting element arrays with respective driving currents (load currents). The step-up controller is configured to detect a lowest cathode voltage of respective cathode voltages of the light emitting element arrays and compare the detected cathode voltage with a reference voltage, thereby producing a control signal for controlling the voltage step-up circuit based on a comparison result.

With the conventional light emitting device, at least one of the constant current drivers (constant current circuits) may adjust a corresponding driving current (load current) to zero. In this case, impedance of the constant current driver in question increases. There is therefore a possibility that a voltage at an output end of the light emitting element array connected in series with the constant current driver (detection value of voltage drop across constant current circuit in question) becomes unstable. The voltage at the output end of the light emitting element array becoming unstable may cause failure of control for the voltage step-up circuit (power supply circuit).

### SUMMARY

It is an object of the present invention to provide a ballast system, a luminaire, a lighting control system, a lighting control method and a non-transitory computer readable medium, capable of stabilizing control for a power supply circuit.

A ballast system according to an aspect of the present disclosure includes a plurality of constant current circuits, a power supply circuit, a plurality of signal paths, a control circuit and pull-up circuits. The plurality of constant current circuits are configured to be connected in series with a respective one of a plurality of light source modules of a light source so that the constant current circuits and the light source modules constitute respective series circuits. The constant current circuits are configured to respectively adjust load currents flowing through the light source modules. The power supply circuit includes a pair of output terminals between which the series circuits are connected in parallel. The power supply circuit are configured to apply a DC voltage across each of the series circuits through the pair of output terminals. The plurality of signal paths provide respective feedback voltages corresponding to voltage drops across the constant current circuits to be respectively applied to the plurality of signal paths. The control circuit is connected with the signal paths. The control circuit is configured to control the power supply circuit so that a target feedback voltage is maintained at a predefined target voltage value, thereby adjusting the DC voltage. The target feedback voltage is a lowest feedback voltage of the feedback voltages. Each of the pull-up circuits includes a first end and a second end and at least two resistors connected in series between the first and second ends to constitute a voltage divider based upon which a predetermined voltage may be applied across the first and second ends. The resistors includes at least two resistors. A junction point of the resistors in each of the pull-up circuits is connected to a corresponding signal path of the plurality of signal paths.

A luminaire according to an aspect of the present disclosure includes the ballast system, and the light source including the light source modules configured to be supplied with DC power from the ballast system.

A lighting control system according to an aspect of the present disclosure includes a series circuit of the ballast system, and a dimmer configured to supply the ballast system with the AC voltage regulated by phase control.

A lighting control method according to an aspect of the present disclosure is executed by the ballast system. The lighting control method includes steps of: acquiring the feedback voltages through the signal paths; choosing, as the target feedback voltage, a lowest feedback voltage from the feedback voltages; and controlling the power supply circuit so that the power supply circuit adjusts the DC voltage by maintaining the target feedback voltage at the target voltage value.

A non-transitory computer readable medium according to an aspect of the present disclosure stores a computer program which, when the computer program is executed by a computer provided for the ballast system, causes the computer to carry out steps of: acquiring the feedback voltages through the signal paths; choosing, as the target feedback voltage, a lowest feedback voltage from the feedback voltages; and controlling the power supply circuit so that the power supply circuit adjusts the DC voltage by maintaining the target feedback voltage at the target voltage value.

### BRIEF DESCRIPTION OF THE DRAWINGS

The figures depict one or more implementations in accordance with the present teaching, by way of example only, not by way of limitation. In the figures, like reference numerals refer to the same or similar elements where:

FIG. 1 is a block diagram of a lighting system according to an embodiment of the present disclosure;

FIG. 2 illustrates signal waveforms of a ballast system in the lighting system according to the embodiment;

FIG. 3 is a circuit diagram of a constant current circuit and a pull-up circuit of the ballast system in the embodiment; and

FIG. 4 is a flow chart showing an operation of the ballast system in the embodiment.

### DETAILED DESCRIPTION

The following embodiments relate generally to ballast systems (current adjusting systems), luminaires, lighting control systems, lighting control methods and non-transitory computer readable media and more particularly, to a ballast system for individual constant current control of constant current circuits, a luminaire, a lighting control system, a lighting control method and a non-transitory computer readable medium. Note that the following embodiments include merely illustrative examples of aspects according to the present disclosure. The disclosure is not limited to the following embodiments, but various modifications are possible in light of general arrangement and the like as long as the advantages of the present disclosure can be obtained.

A ballast system, a luminaire, a lighting control system, a lighting control method and a non-transitory computer readable medium, according to the embodiment are mainly available for dwellings such as detached houses, apartments and flats. The ballast system, the luminaire, the lighting control system, the lighting control method and the non-transitory computer readable medium, according to the embodiment are also applicable to offices, factories, stores and the like.

Hereinafter, the embodiment will be explained with reference to the drawings.

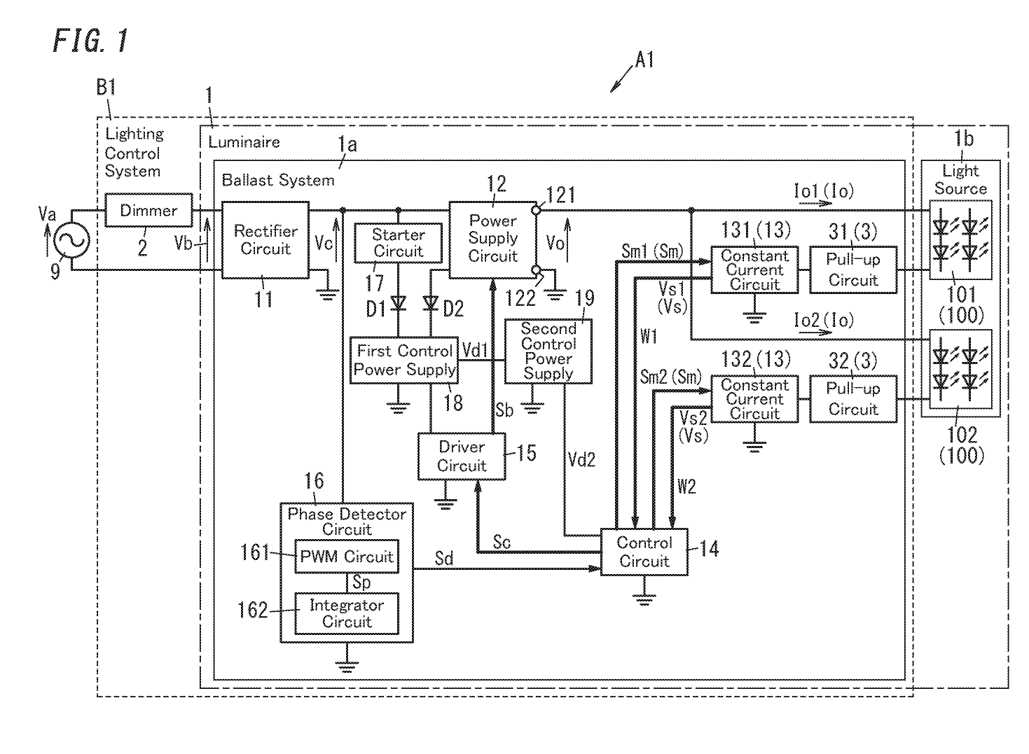

As shown in FIG. 1, a lighting system Al according to the embodiment includes a luminaire 1 and a dimmer 2. The luminaire 1 is connected between both ends of an AC power supply 9 through the dimmer 2.

The dimmer 2 is configured to regulate, by phase control, an alternating current (AC) voltage Va supplied from the AC power supply 9 to the luminaire 1. That is, the luminaire 1 is supplied with a voltage derived from the phase control by the dimmer 2—a phase-controlled voltage Vb. The dimmer 2 regulates a duty cycle as an on-period per half wave of the phase-controlled voltage Vb (conduction angle or phase angle), thereby enabling the luminaire 1 to adjust light output and light (luminous) color according to the conduction angle.

The luminaire 1 is a luminaire configured to adjust light output and light color, and includes a ballast system la and a light source 1b as shown in FIG. 1. The ballast system la and the light source 1b may be housed in a common enclosure in an integral manner. Alternatively, the ballast system la and the light source 1b may be formed separately from each other. FIG. 1 also shows a lighting control system B1 including the ballast system la and the dimmer 2.

The ballast system la includes a rectifier circuit 11, a power supply circuit 12, a plurality of (e.g., two) constant current circuits 13, a control circuit 14, a driver circuit 15, a phase detector circuit 16, a starter circuit 17, a first control power supply 18, a second control power supply 19, diodes D1 and D2, and a plurality of (e.g., two) pull-up circuits 3.

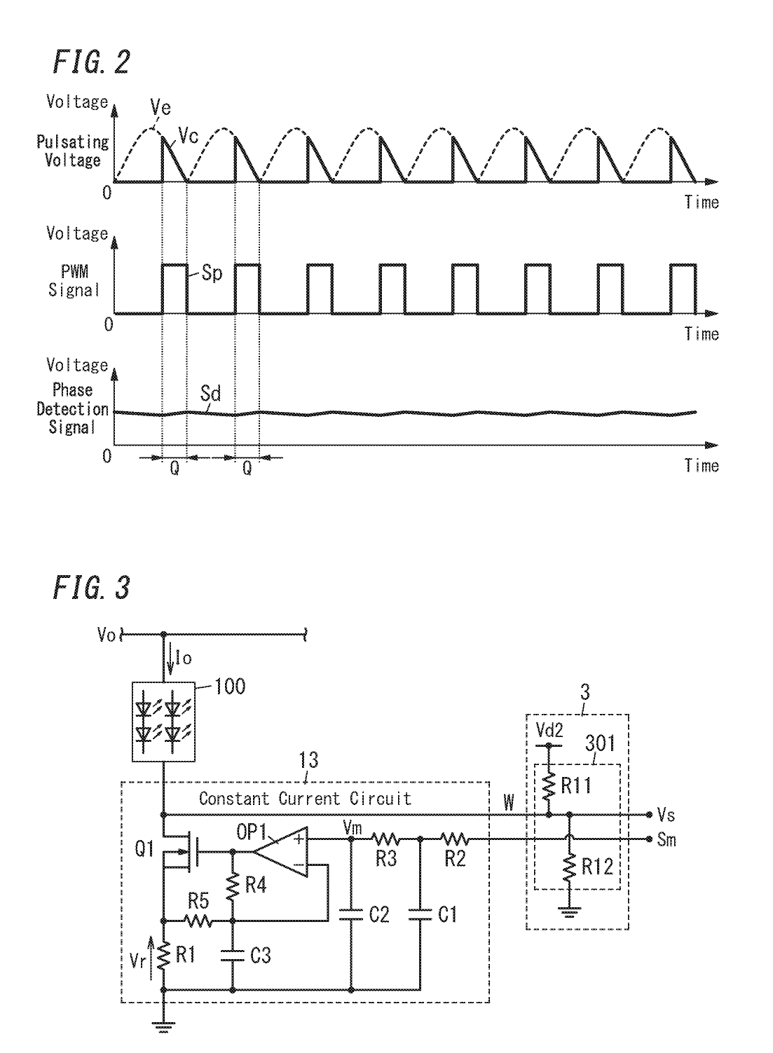

The rectifier circuit 11 may be a full-wave rectifier including a diode bridge and the like. In this case, the rectifier circuit 11 is configured to receive the phase-controlled voltage Vb derived from the phase control by the dimmer 2 to full-wave rectify the phase-controlled voltage Vb, thereby outputting a pulsating voltage Vc. The upper part of FIG. 2 shows a waveform of the pulsating voltage Vc. The pulsating voltage Vc is a phase-controlled voltage derived from the phase control like the phase-controlled voltage Vb. Here, a period of time as a conduction state per half wave of the pulsating voltage Vc corresponds to a conduction angle θ. Note that a short dashed line in the upper part of FIG. 2 shows a waveform of a full-wave rectified voltage Ve derived from full-wave rectification of the AC voltage Va. The ballast system la may include a filter circuit in front of the rectifier circuit 11. For example, the filter circuit includes an inductor for noise reduction, a capacitor for noise reduction and a surge absorber, and is configured to attenuate unwanted frequency components (e.g., high-frequency noise).

The power supply circuit 12 is configured to receive the pulsating voltage Vc to convert the pulsating voltage Vc into a prescribed direct current (DC) voltage Vo. The power supply circuit 12 may include a first output terminal 121 and a second output terminal 122 as a pair of output terminals, and output the DC voltage Vo from the first and second output terminals 121 and 122. For example, the first output terminal 121 corresponds to a high potential (electric potential) side of the DC voltage Vo, while the second output terminal 122 corresponds to a low potential side of the DC voltage Vo. The power supply circuit 12 may be a DC/DC converter (switching power supply circuit) including at least a semiconductor switching device, and turn the semiconductor switching device on and off, thereby converting the pulsating voltage Vc into the DC voltage Vo. The power supply circuit 12 may include a non-isolated flyback converter, an LLC resonant converter, or the like. Note that the power supply circuit 12 preferably has a power factor correction function.

The light source 1b includes light source modules 100 that are individually connected in series with the constant current circuits 13. In the present embodiment, the light source 1b includes two light source modules 100 that correspond one-to-one to the two constant current circuits 13. The two constant current circuits 13 are configured to adjust respective load currents supplied to the two light source modules 100.

The light source 1b includes, as the two light source modules 100, a light source module 101 and a light source module 102. The light source module 101 is a light source having first light color. In the present embodiment, the light source module 101 includes LEDs configured to emit light having a first color temperature as warm color corresponding to a relatively low color temperature. The first color temperature is set to, for example a value in a range of 2600 to 3250 K corresponding to light bulb color defined in Japanese Industrial Standards (JIS) Z 9112. The light source module 102 is a light source having second light color different from that of the light source module 101. In the present embodiment, the light source module 102 includes LEDs configured to emit light having a second color temperature as cool color corresponding to a relatively high color temperature. The second color temperature is set to, for example a value in a range of 5700 to 7100 K corresponding to tropical daylight color defined in JIS Z 9112.

In the configuration example stated above, light emitted from the light source 1b is color mixing light of respective light emitted from the light source modules 101 and 102. It is therefore possible to adjust the light quantity (luminous flux) and light color of the color mixing light emitted from the light source 1b by adjusting respective light quantities of the light source modules 101 and 102. Note that the LEDs of the light source module 101 may be connected in series, or in series and parallel. In addition, the LEDs of the light source module 102 may be connected in series, or in series and parallel.

Each of the constant current circuits 13 is configured to adjust a value of a load current Io flowing through a corresponding light source module 100 to a target current value. In the present embodiment, a constant current circuit 131 and a constant current circuit 132 are provided as the two constant current circuits 13. The constant current circuit 131 is configured to adjust a value of a load current Io1 flowing through the light source module 101 to a first target current value. The constant current circuit 132 is configured to adjust a value of a load current Io2 flowing through the light source module 102 to a second target current value.

The constant current circuit 131 may be connected in series with the light source module 101 between the first and second output terminals 121 and 122 of the power supply circuit 12. In this example, the DC voltage Vo is to be applied across a series circuit of the light source module 101 and the constant current circuit 131. Note that the light source module 101 is connected to a high potential side of the DC voltage Vo, while the constant current circuit 131 is connected to a low potential side thereof.

The constant current circuit 132 may be connected in series with the light source module 102 between the first and second output terminals 121 and 122 of the power supply circuit 12. In this example, the DC voltage Vo is to be applied across a series circuit of the light source module 102 and the constant current circuit 132. Note that the light source module 102 is connected to the high potential side, while the constant current circuit 132 is connected to the low potential side.

The phase detector circuit 16 (detector circuit) is configured to receive, from an outside, indication information indicating a lighting state of the light source 1b. In the present embodiment, the conduction angle θ of the phase-controlled voltage Vb corresponds to the indication information. For examples, the lighting state of the light source 1b means at least one of a dimmed state, which is a state in which the light source 1b is lit at brightness (light output) according to the indication information (the brightness is brightness of the entire light source 1), and a color developed state, which is a state in which the light source 1b is lit at a light (luminous) color according to the indication information. The lighting state of the light source 1b may be respective values of the load currents Io1 and Io2 through the light source modules 101 and 102. That is, the indication information directly or indirectly represents the respective values of the load currents Io1 and Io2 through the light source modules 101 and 102.

The phase detector circuit 16 may include a pulse width modulation (PWM) circuit 161 and an integrator circuit 162. Here, the upper part of FIG. 2 shows the waveform of the pulsating voltage Vc. The middle part of FIG. 2 shows the waveform of a PWM signal Sp from the PWM circuit 161. The lower part of FIG. 2 shows the waveform of a phase detection signal Sd from the integrator circuit 162.

The PWM circuit 161 is, for example a circuit configured to produce the PWM signal Sp based on the waveform of the pulsating voltage Vc. In this example, the PWM circuit 161 may be configured to compare the pulsating voltage Vc with a criterion value to obtain a comparison result, thereby outputting the PWM signal Sp produced based on the comparison result. Here, the PWM signal Sp is a pulse train signal synchronized with the pulsating voltage Vc (phase-controlled voltage Vb) as shown in the middle part of FIG. 2. ON duty of the PWM signal Sp corresponds to the conduction angle θ. Specifically, the ON duty of the PWM signal Sp increases as the conduction angle θ increases. The ON duty of the PWM signal Sp also decreases as the conduction angle θ decreases.

The integrator circuit 162 is, for example an integrator circuit including a resistor and a capacitor. In this example, the integrator circuit 162 may be configured to provide the control circuit 14 with the phase detection signal Sd obtained by integrating the PWM signal Sp. As shown in the lower part of FIG. 2, the phase detection signal Sd is a DC voltage signal. A voltage value of the phase detection signal Sd (or average voltage value) corresponds to a value of the conduction angle θ. That is, the phase detection signal Sd contains information representing the conduction angle θ (indication information). Specifically, the voltage value of the phase detection signal Sd increases as the conduction angle θ increases. The voltage value of the phase detection signal Sd also decreases as the conduction angle θ decreases.

The control circuit 14 includes, for example a computer system mainly including a processor and a memory. In this example, the control circuit 14 may be configured to provide the constant current circuits 131 and 132 with respective target value signals Sm1 and Sm2 based on the phase detection signal Sd. The target value signal Sm1 is a PWM signal, ON duty of which is set according to a first target current value (target value of load current Io1). The ON duty of the target value signal Sm1 increases as the first target current value increases. The target value signal Sm2 is a PWM signal, ON duty of which is set according to a second target current value (target value of load current Io2). The ON duty of the target value signal Sm2 increases as the second target current value increases.

Preferably, the memory of the control circuit 14 previously stores data defining respective ON duty of the target value signals Sm1 and Sm2 associated with content of the indication information. For example, the memory of the control circuit 14 previously stores, in the form of a table, an arithmetic expression or the like, a correspondence relation between each value in an entire range defined by voltage values derived from the phase detection signal Sd, and respective ON duty of corresponding target value signals Sm 1 and Sm2. That is, the control circuit 14 previously stores the relation representing respective target current values associated with the light source modules 101 and 102 by indication information.

In the above specific example, the constant current circuit 131 is configured to receive the target value signal Sm1 to adjust the load current Io1 so that the value of the load current Io1 is maintained at (approaches) the first target current value. The constant current circuit 132 is configured to receive the target value signal Sm2 to adjust the load current Io2 so that the value of the load current Io2 is maintained at (approaches) the second target current value. Thus, individually controlling the load currents Io1 and Io2 supplied to the light source modules 101 and 102 according to the phase detection signal Sd enables the control circuit 14 to adjust the light output and the light color of the light source 1b.

For example, the control circuit 14 may vary the light quantity and the color temperature of the color mixing light emitted from the light source 1b according to the conduction angle θ (phase detection signal Sd). The dimming level for the light source 1b is a dimming lower limit when the conduction angle θ is a lower limit. Note that the light source 1b may be unlit when the conduction angle θ is the lower limit. When the conduction angle θ is in a range greater than the lower limit, the light output and the light color are adjusted according to the increase and decrease of the conduction angle θ. For example, the color mixing light becomes light having the color temperature of 2800 K (light bulb color) when the conduction angle θ is a middle value. The color mixing light also becomes light having the color temperature of 5000 K (tropical daylight color) when the conduction angle θ is a upper limit.

FIG. 3 shows a configuration of the constant current circuit 13 (each of 131 and 132). The constant current circuits 13 include their respective semiconductor switching devices Q1 connected in series with the light source modules 101 and 102. The constant current circuits 13 are configured to adjust respective currents flowing through the semiconductor switching devices Q1 (drain currents), thereby adjusting the load currents Io. Each constant current circuits 13 includes an operational amplifier OP1, the semiconductor switching device Q1, resistors R1 to R5, and capacitors C1 to C3. Hereinafter, each semiconductor switching device Q1 is abbreviated to a “switching device Q1”.

A specific example of FIG. 3 is now explained. A non-inverted input terminal of the operational amplifier OP1 is supplied with the target value signal Sm (target value signal Sm1 or Sm2) via integrator circuits composed of the resistors R2 and R3, and the capacitors C1 and C2. A series circuit of the resistors R2 and R3 is connected in series with a transmission path of the target value signal Sm. The capacitor C1 is connected between the second output terminal 122 and a junction point of the resistors R2 and R3. The capacitor C2 is connected between the non-inverted input terminal of the operational amplifier OP1 and the second output terminal 122. That is, the resistors R2 and R3, and the capacitors C1 and C2 constitute tandem two integrator circuits. Therefore, the target value signal Sm as the PWM signal is converted into an integral voltage Vm through the resistors R2 and R3, and the capacitors C1 and C2. The integral voltage Vm is then supplied to the non-inverted input terminal of the operational amplifier OP1. The resistor R4 is further connected between an output terminal and an inverted input terminal of the operational amplifier OP1.

In the specific example of FIG. 3, the output terminal of the operational amplifier OP1 is connected to a control terminal of the switching device Q1. In the present embodiment, the switching device Q1 is a Metal Oxide Semiconductor Field Effect Transistor (MOSFET), and the control terminal is a gate. The operational amplifier OP1 provides the gate of the switching device Q1 with a gate voltage from the output terminal, and increases and decreases the gate voltage, thereby adjusting resistance between a drain and a source of the switching device Q1.

In the specific example, the drain of the switching device Q1 is connected to a cathode side of the light source module 100 (101, 102), and the source of the switching device Q1 is connected to a first end of the resistor R1. A second end of the resistor R1 is connected to the second output terminal 122 of the power supply circuit 12. That is, a series circuit of the light source module 100, the switching device Q1 and the resistor R1 is connected between the first and second output terminals 121 and 122 of the power supply circuit 12, and supplied with the DC voltage Vo.

In the specific example, the resistor R1 is supplied with the load current Io (Io1, Io2), and therefore a detected voltage Vr proportionate to the load current Io occurs across both the ends of the resistor R1. The detected voltage Vr is applied across a series circuit of the resistor R5 and the capacitor C3. A junction point of the resistor R5 and the capacitor C3 is connected to the non-inverted input terminal of the operational amplifier OP1.

Thus, the operational amplifier OP1 adjusts the gate voltage applied to the gate of the switching device Q1 so that a value of the detected voltage Vr (voltage across capacitor C3) is maintained at (approaches) a value of the integral voltage Vm. The load current Io (drain current) is consequently adjusted so that the value of the detected voltage Vr is maintained at (approaches) the value of the integral voltage Vm. That is, the ON duty of the target value signal Sm is increased and decreased, thereby increasing and decreasing the load current Io. Therefore, the load current Io increases as the target current value (first target current value, second target current value) increases. The load current Io also decreases as the target current value decreases

In the specific example of FIG. 3, the drain of the switching device Q1 is connected to the control circuit 14 via the signal path W. A voltage drop across a series circuit of the switching device Q1 and the resistor R1 (voltage between both ends of series circuit) is transmitted as a feedback voltage Vs to the control circuit 14 via the signal path W. More specifically, the constant current circuit 131 is configured to provide the control circuit 14 with a feedback voltage Vs1 via a signal path W1. The constant current circuit 132 is configured to provide the control circuit 14 with a feedback voltage Vs2 via a signal path W2. Note that a value of the feedback voltage Vs1 corresponds to a value of the voltage drop in the constant current circuit 131, and a value of the feedback voltage Vs2 corresponds to a value of the voltage drop in the constant current circuit 132.

In addition, the DC voltage Vo containing a ripple voltage causes the feedback voltage Vs to have a waveform containing the ripple voltage.

Returning to FIG. 1, the first control power supply 18 is configured to receive electric power from the starter circuit 17 or the power supply circuit 12 to output a first control voltage Vd1 as a DC voltage. The first control voltage Vd1 serves as an operating voltage for the driver circuit 15.

The starter circuit 17 is configured to provide the first control power supply 18 with the pulsating voltage Vc during an activation period (startup period) in which the dimmer 2 starts supplying the ballast system la with electric power from the AC power supply 9. During the activation period, the first control power supply 18 receives the pulsating voltage Vc to output the first control voltage Vd1.

After a transition from the activation period to a steady period, the starter circuit 17 stops outputting the pulsating voltage Vc. The power supply circuit 12 includes, for example a transformer and a switching device. The power supply circuit 12 is configured to, during the steady period, perform on-off switching operation of the switching device, thereby allowing a current to flow through a primary winding of the transformer and also shutting off the current. The DC voltage Vo is generated by an induced voltage from a secondary winding of the transformer. The first control power supply 18 is also supplied with an induced voltage from a third winding of the transformer. That is, during the steady period, the first control power supply 18 receives the induced voltage obtained by the switching operation of the power supply circuit 12 to output the first control voltage Vd1.

The driver circuit 15 is configured to be activated by the first control voltage Vd1 and receive a switching control signal Sc from the control circuit 14 to produce a drive signal Sb based on the switching control signal Sc. The driver circuit 15 provides the drive signal Sb to the power supply circuit 12 to turn a switching device of the driver circuit 15 on and off.

The second control power supply 19 is configured to receive the first control voltage Vd1 to output a second control voltage Vd2 as a DC voltage. The second control voltage Vd2 serves as an operating voltage for the control circuit 14. Note that in the present embodiment the second control voltage Vd2 is, but not limited to, lower than the first control voltage Vd1. Each of the first and second control power supplies 18 and 19 may be either a switching power supply or a linear power supply.

The control circuit 14 is configured to produce the switching control signal Sc based on the feedback voltages Vs1 and Vs2 to provide the switching control signal Sc to the driver circuit 15. That is, a value of the DC voltage Vo provided from the power supply circuit 12 is determined based on the feedback voltages Vs1 and Vs2.

As stated above, in the present embodiment, the constant current circuit 131 adjusts the load current Io1 so that a value of the load current Io1 is maintained at (approaches) the first target current value. The constant current circuit 131 also adjusts the load current Io2 so that a value of the load current Io2 is maintained at (approaches) the second target current value. In this case, a voltage drop across each series circuit of the switching device Q1 and the resistor R1 (feedback voltage Vs) needs to be maintained at greater than or equal to a prescribed voltage in order to reduce influence of the ripple voltage of the DC voltage Vo on the light source modules 100.

However, the light source 1b according to the present embodiment includes the light source modules 101 and 102. It is therefore necessary to individually adjust respective load currents Io1 and Io2 flowing through the light source modules 101 and 102 in order to adjust the light color of the light source 1b. This makes it difficult to adjust respective forward voltages of the light source modules 101 and 102 to the same value.

In order to light the light source modules 100 at the same time, respective forward voltages of all the light source modules 100 when they are lit need to be greater than or equal to their respective lighting start voltages. When a value of the forward voltage of a light source module 100 is less than the lighting start voltage thereof, the light source module 100 is not lit or generates a flicker. If a value of the DC voltage Vo is fixed to a constant value, unnecessary power losses may occur in the constant current circuits 13.

In order to solve the above-mentioned issues, the value of the DC voltage Vo needs to be adjusted to a value of a voltage, which enables respective load currents Io to flow through all light source modules 100 to be lit, with power losses by the constant current circuits 13 reduced as much as possible.

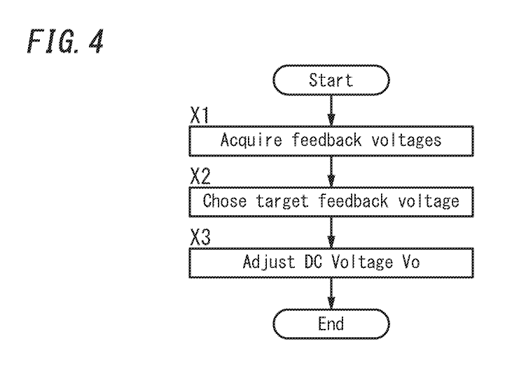

Therefore, the control circuit 14 according to the present embodiment will perform a voltage control process according to a flow chart shown in FIG. 4 to control the power supply circuit 12 based on the feedback voltages Vs1 and Vs2, thereby adjusting a value of the DC voltage Vo.

After the transition from the activation period to the steady period (after activation), the control circuit 14 first adjusts the DC voltage Vo to a predetermined initial voltage value. The initial voltage value is a value of a voltage that is sufficiently high and allows the load currents Io1 and Io2 to flow through the light source modules 101 and 102, respectively. The control circuit 14 acquires the feedback voltages Vs1 and Vs 2 during the steady period (step X1).

The control circuit 14 then compares respective values of the feedback voltages Vs1 and Vs 2 to choose, as a target feedback voltage, a lower feedback voltage (step X2). Here, let the feedback voltage Vs1 be lower than the feedback voltage Vs2, and let the target feedback voltage be Vs1. A forward voltage of the light source module 101 corresponding to the target feedback voltage Vs1 is greater than a forward voltage of the light source module 102. Note that in the case of three or more feedback voltages Vs, the target feedback voltage is the lowest feedback voltage Vs of the three or more feedback voltages Vs.

The control circuit 14 then produce a switching control signal Sc for controlling the power supply circuit 12 so that the target feedback voltage Vs1 is maintained at (approaches) the target voltage value, and output the switching control signal Sc. The DC voltage Vo is consequently controlled so that the target feedback voltage Vs1 is maintained at (approaches) the target voltage value.

The control circuit 14 subsequently repeats the above-mentioned steps X1 to X3 to adjust the DC voltage Vo.

The memory of the control circuit 14 stores the data on the target voltage value in advance. The target voltage value is a value of the feedback voltage Vs that enables both of the light source modules 101 and 102 to be lit with respective power losses by the constant current circuits 131 and 132 reduced as much as possible.

When each switching device Q1 is a MOSFET, setting examples of the target voltage value include first to fourth examples below. In the first example, the target voltage value is set to a value of a drain-source voltage in a transition from a non-saturation region (linear region or ohmic region: first region) to a saturation region (second region) of the switching device Q1. In the second example, the target voltage value is set to a value of a drain-source voltage in a transition from the saturation region to the non-saturation region of the switching device Q1. In the third example, the target voltage value is set to a value obtained by adding a margin voltage to the drain-source voltage in the transition from the non-saturation region to the saturation region of the switching device Q1. In the fourth example, the target voltage value is set to a value obtained by adding a margin voltage to the drain-source voltage in the transition from the saturation region to the non-saturation region of the switching device Q1. That is, the target voltage value is set based on the drain-source voltage in the transition from the non-saturation region to the saturation region of the switching device Q1, where a ratio of a change in a drain current of the switching device Q1 to a change in the drain-source voltage thereof in the non-saturation region is greater than a ratio of a change in a drain current of the switching device Q1 to a change in the drain-source voltage thereof in the saturation region. Note that when the constant current circuits 13 respectively include switching devices Q1 of the same type such as part (device) number, the value of the drain-source voltage may be set to a corresponding standard value in a data sheet containing the switching device Q1 of a corresponding type. Alternatively, when the constant current circuits 13 respectively include switching devices Q1 of different types, the value of the drain-source voltage may be set to a mean value of respective drain-source voltages of the switching devices Q1 of different types.

When each switching device Q1 is a bipolar transistor, setting examples of the target voltage value include first to fourth examples below. In the first example, the target voltage value is set to a collector-emitter voltage in a transition from a saturation region (first region) to an active region (second region) of the switching device Q1. In the second example, the target voltage value is set to a collector-emitter voltage in a transition from the active region to the saturation region. In the third example, the target voltage value is set to a value obtained by adding a margin voltage to the collector-emitter voltage in the transition from the saturation region to the active region of the switching device Q1. In the fourth example, the target voltage value is set to a value obtained by adding a margin voltage to the collector-emitter voltage in the transition from the active region to the saturation region of the switching device Q1.

As stated above, the control circuit 14 chooses the target feedback voltage to adjust the DC voltage Vo so that the target feedback voltage is maintained at (approaches) the target voltage value. It is accordingly possible to apply a forward voltage greater than or equal to a lighting start voltage to each of the light source modules 101 and 102, thereby preventing the light source modules 101 and 102 from being unlit and generating a flicker.

The pull-up circuits 3 will be next explained.

As shown in FIG. 1, the ballast system la includes, for example two pull-up circuits 3 that include pull-up circuits 31 and 32 connected to the constant current circuits 131 and 132, respectively.

As shown in FIG. 3, each pull-up circuit 3 may include a voltage divider circuit 301 composed of resistors R11 and R12 connected in series. The resistor R11 allows high potential of the second control voltage Vd2 to be applied to a first end thereof. Here, the first end of the resistor R11 corresponds to a first end of a series circuit of the resistors R11 and R12. A second end of the resistor R11 is connected to a first end of the resistor R12, and the junction point of the resistors R11 and R12 is connected to a signal path W. A second end of the resistor R12 is connected to the second output terminal 122 of the power supply circuit 12. The resistor R12 allows low potential of the DC voltage Vo to be applied to the second end thereof. Here, the second end of the resistor R12 corresponds to a second end of the series circuit of the resistors R11 and R12. In short, the high potential of the second control voltage Vd2 is applied to the first end of the series circuit of the resistors R11 and R12. The low potential of the DC voltage Vo is applied to the second end of the series circuit of the resistors R11 and R12. The second control voltage Vd2 is therefore applied between the first and second ends of the series circuit of the resistors R11 and R12.

For example, the potential at the second output terminal 122 of the power supply circuit 12 (low potential of DC voltage Vo) serves as circuit ground. The control circuit 14 may perform signal processing based on the circuit ground.

The load currents Io1 and Io2 depend on color adjustment levels for the light source 1b, which may make any one of the load currents Io1 and Io2 zero, thereby extinguishing it. For example, in a configuration in which no pull-up circuits 3 are provided, when the switching device Q1 of a constant current circuit 131 is in an OFF state, the load current Io1 is zero and impedance between the signal path W1 and the circuit ground (second output terminal 122 of power supply circuit 12) has a very large value, thereby electrically disconnecting the signal path W1 from the circuit ground. This renders potential on the signal path W1 unstable. As a result, a value of the feedback voltage Vs1 becomes unstable. The value of the feedback voltage Vs1 becoming unstable make it difficult for the control circuit 14 to accurately choose the target feedback voltage. This may bring about adjustment failure of the DC voltage Vo from the power supply circuit 12.

Therefore, in order to stabilize the potential on the signal path W1 even if the switching device Q1 is in an OFF state, the potential on the signal path W1 is determined by the pull-up circuit 3. When the switching device Q1 is in an OFF state, a divided voltage is applied to the signal path W. The divided voltage is obtained by dividing the second control voltage Vd2 by the resistors R11 and R12 and represented by [Vd2]×[R121/([R11]+[R121), where [Vd2] represents a value of the second control voltage, [R11] represents a value of the resistor R11, and [R12] represents a value of the resistor R12.

Here, let first potential be potential on a signal path W corresponding to a turned-off switching device Q1 (load current Io=0). The first potential is determined by a value of the divided voltage by the resistors R11 and R12. In addition, let second potential be potential on a signal path W corresponding to a switching device Q1 that is not in an OFF state (load current Io≠0). The second potential is determined by a voltage drop in the constant current circuit 13 (sum of respective voltage drops across switching device Q1 and resistor R1 by load current Io). Every first potential on every signal path W is greater than every second potential. That is, the value of the divided voltage is set to be greater than the target voltage value, and the feedback voltage Vs of another constant current circuit 13, a switching device Q1 of which is not in an OFF state. It is therefore possible to prevent the feedback voltage Vs of a constant current circuit 13 whose switching device Q1 is in an OFF state from being chosen as the target feedback voltage.

In the configuration provided with one power supply circuit 12 configured to output a DC voltage Vo, when the constant current circuits 13 adjust respective load currents Io of the light source modules 100, it is possible to control the power supply circuit 12 regardless of respective values of the load currents Io, thereby enabling the ballast system la to stabilize the control of the power supply circuit 12.

Preferably, the resistors R11 and R12 each have their own comparatively large resistance values (e.g., several kΩ or more) in order to suppress the influence on the feedback voltages Vs. Each pull-up circuit 3 may include a voltage divider composed of three or more resistors in series. In this case, a junction point of a series circuit composed of any two resistors of the three or more resistors is connected to a corresponding signal path W.

The voltage applied to the voltage divider circuit 301 may be the first control voltage Vd1 in place of the second control voltage Vd2, or other DC voltages.

The control circuit 14 in the embodiment may include a computer system. In this case, the computer system may mainly include hardware such as a processor and a memory. With the computer system, the processor executes a program stored in the memory, thereby realizing functions of the control circuit 14 in the present disclosure. The program may be stored in the memory of the computer system in advance, provided via a telecommunications line, or provided through a non-transitory computer readable medium such as a memory card, an optical disk, or a hard disk drive. The processor of the computer system may be composed of one or more electronic circuits including semiconductor integrated circuits (ICs) or large scale integrated (LSI) circuits. The electronic circuits may be consolidated into one chip or provided in chips in a dispersed manner. The chips may be consolidated into one device or provided in devices in a dispersed manner.

The control circuit 14 is not limited to the computer system. Examples of the control circuit 14 may further include an Application Specific Integrated Circuit (ASIC), a Field Programmable Gate Array (FPGA), and a control integrated circuit (IC).

Each of solid light emitting devices of the light source 1b is not limited to an LED. Examples thereof may further include other solid light emitting devices such as an Organic Electro Luminescence (OEL) and an Inorganic EL. The light source 1b may be also composed of not only the solid light emitting devices but also one solid light emitting device. The solid light emitting devices may be electrically connected in series or parallel, or connected in series and parallel.

The luminaire 1 in the present embodiment may include the light source modules 100, the constant current circuits 13 and the pull-up circuits 3 two or more each.

As stated above, a ballast system la according to a first aspect includes a plurality of constant current circuits 13, a power supply circuit 12, a plurality of signal paths W, a control circuit 14, and pull-up circuits 3. The plurality of constant current circuits 13 are configured to be connected in series with a respective one of a plurality of light source modules 100 of a light source 1b so that the constant current circuits 13 and the light source modules 100 constitute respective series circuits. The constant current circuits 13 is configured to respectively adjust load currents Io flowing through the light source modules 100. The power supply circuit 12 includes a pair of output terminals 121 and 122 between which the series circuits are connected in parallel. The power supply circuit 12 is configured to apply a DC voltage Vo across each of the series circuits through the pair of output terminals 121 and 122. The plurality of signal paths W provide respective feedback voltages Vs corresponding to voltage drops across the constant current circuits 13 to be respectively applied to the plurality of signal paths W. The control circuit 14 is connected with the signal paths W. The control circuit 14 is configured to control the power supply circuit 12 so that a target feedback voltage is maintained at a predefined target voltage value, thereby adjusting the DC voltage Vo. The target feedback voltage is a lowest feedback voltage of the feedback voltages Vs. Each of the pull-up circuits 3 includes a first end and a second end and at least two resistors R11 and R12. The resistors R11 and R12 are connected in series between the first and second ends to constitute a voltage divider circuit 301 based upon which a predetermined voltage Vd2 may be applied across the first and second ends. A junction point of the resistors R11 and R12 in each of the pull-up circuits 3 is connected to a corresponding signal path W of the plurality of signal paths W.

The ballast system la includes one power supply circuit 12 configured to output the DC voltage Vo, and the constant current circuits 131 and 132 adjust respective load currents Io1 and Io2 through the light source modules 101 and 102. The first aspect enables the ballast system la to control the power supply circuit 12 regardless of respective values of the load currents Io1 and Io2, thereby stabilizing control of the power supply circuit 12.

In the first aspect, a ballast system la according to a second aspect preferably further includes a detector circuit 16 configured to acquire indication information indicating a lighting state of the light source 1b. The light source modules 100 have respective light (luminous) colors that are different from each other. The control circuit 14 is configured to, based on a predetermined relation representing respective current values associated with the light source modules 100 by the indication information on the light source 1b, provide the constant current circuits 13 with, as respective target current values for the light source modules 100, respective current values associated with the light source modules 100 in the predetermined relation, corresponding to the indication information acquired through the detector circuit 16. The constant current circuits 13 are configured to adjust the respective load currents Io so that the respective load currents Io flowing through the light source modules 100 are maintained at the respective target current values for the light source modules 100 from the control circuit 14.

The second aspect enables the ballast system la to adjust the light output and the light color of the light source 1b.

In the second aspect, as a ballast system la according to a third aspect, the power supply circuit 12 is preferably configured to convert a pulsating voltage obtained by rectifying an AC voltage Va regulated by phase control into the DC voltage Vo. The detector circuit 16 is configured to acquire, as the indication information, information corresponding to a conduction angle θ (on-period) corresponding to the phase control.

The third aspect enables the ballast system la to receive both of load power and indication information by the pulsating voltage Vc (phase-controlled voltage), thereby controlling the light output and the light color based on the indication information.

In the third aspect, as a ballast system la according to a fourth aspect, the detector circuit 16 is preferably configured to acquire, as the information corresponding to the conduction angle θ corresponding to the phase control, a phase detection signal Sd, a voltage of which increases as the conduction angle θ increases and decreases as the conduction angle θ decreases. The control circuit 14 is configured to receive, as the indication information, the phase detection signal Sd.

In any one the first to fourth aspects, as a ballast system la according to a fifth aspect, each of the constant current circuits 13 includes a semiconductor switching device Q1 connected in series with a corresponding light source module 100 of the light source modules 100, and is also configured to regulate a current flowing through the semiconductor switching device Q1, thereby adjusting a load current Io flowing through the corresponding light source module 100. The target voltage value is set based on a voltage across a semiconductor switching device Q1 of each of the constant current circuits 13 in a transition between a first region and a second region in operational regions of the semiconductor switching device Q1. Preferably, a ratio of a change in a current flowing through the semiconductor switching device Q1 to a voltage across the semiconductor switching device Q1 in the first region is larger than that in the second region.

The fifth aspect enables ballast system la to light both of the light source modules 101 and 102 and reduce respective power losses by the constant current circuits 131 and 132 as much as possible.

In any one the first to fifth aspects, as a ballast system la according to a sixth aspect, the control circuit 14 is preferably configured to maintain the DC voltage Vo at a predetermined initial voltage value after activation of the control circuit 14, and choose the target feedback voltage from the feedback voltages Vs. The control circuit 14 is also configured to control the power supply circuit 12 so that a difference between a value of the target feedback voltage and the target voltage value is reduced, thereby adjusting the DC voltage Vo.

The sixth aspect enables the ballast system la to stabilize the control of the power supply circuit 12.

In any one the first to sixth aspects, as a ballast system la according to a seventh aspect, each potential on the signal paths W is first potential when a corresponding constant current circuit 13 of the constant current circuits 13 adjusts, to zero, a load current Io flowing a corresponding light source module 100 of the light source modules 100. The first potential is potential at a junction point of the resistors R11 and R12 in a corresponding pull-up circuit 3 of the pull-up circuits 3. Each potential on the signal paths W is also second potential by a voltage drop across the corresponding constant current circuit 13 when the corresponding constant current circuit 13 does not adjust, to zero, the load current Io flowing the corresponding light source module 100. Each first potential is higher than each second potential.

A luminaire 1 according to an eighth aspect includes a ballast system la of any one of the first to seventh aspects, and the light source 1b including the light source modules 101 and 102 configured to be supplied with DC power from the ballast system 1a.

The eighth aspect enables the luminaire 1 to stabilize the control of the power supply circuit 12.

A lighting system B1 according to a ninth aspect includes a series circuit of: the ballast system la of the third aspect; and a dimmer 2 configured to supply the ballast system la with the AC voltage Va regulated by the phase control.

The ninth aspect enables the lighting system B1 to stabilize the control of the power supply circuit 12, and receive both load power and the indication information by the phase control, thereby adjusting the light output and the light color based on the indication information.

A computer program according to a tenth aspect includes instructions which, when the computer program is executed by a computer provided for a ballast system la of any one of the first to eighth aspect, causes the computer to carry out steps of: acquiring the feedback voltages Vs through the signal paths W; choosing, as the target feedback voltage, a lowest feedback voltage from the feedback voltages Vs; and adjusting the DC voltage Vo so that the target feedback voltage is maintained at the target voltage value.

The tenth aspect enables the computer program to stabilize the control of the power supply circuit 12.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the claims to claim any and all modifications and variations that fall within the true scope of the present teachings.

1. A ballast system, comprising:
a plurality of constant current circuits configured to be connected in series with a respective one of a plurality of light source modules of a light source so that the constant current circuits and the light source modules constitute respective series circuits, the constant current circuits being configured to respectively adjust load currents flowing through the light source modules;
a power supply circuit that includes a pair of output terminals between which the series circuits are connected in parallel, the power supply circuit being configured to apply a DC voltage across each of the series circuits through the pair of output terminals;
a plurality of signal paths that provide respective feedback voltages corresponding to voltage drops across the constant current circuits to be respectively applied to the plurality of signal paths;
a control circuit that is connected with the signal paths, the control circuit being configured to control the power supply circuit so that a target feedback voltage is maintained at a predefined target voltage value, thereby adjusting the DC voltage, the target feedback voltage being a lowest feedback voltage of the feedback voltages; and
pull-up circuits, each of which includes a first end and a second end and at least two resistors connected in series between the first and second ends to constitute a voltage divider based upon which a predetermined voltage may be applied across the first and second ends,
a junction point of the resistors in each of the pull-up circuits being connected to a corresponding signal path of the plurality of signal paths.

2. The ballast system of claim 1, further comprising
a detector circuit configured to acquire indication information indicating a lighting state of the light source, wherein
the light source modules have respective light colors that are different from each other,
the control circuit is configured to, based on a predetermined relation representing respective current values associated with the light source modules by the indication information on the light source, provide the constant current circuits with, as respective target current values for the light source modules, respective current values associated with the light source modules in the predetermined relation, corresponding to the indication information acquired through the detector circuit, and
the constant current circuits are configured to adjust the respective load currents so that the respective load currents flowing through the light source modules are maintained at the respective target current values for the light source modules from the control circuit.

3. The ballast system of claim 2, wherein
the power supply circuit is configured to convert a pulsating voltage obtained by rectifying an AC voltage regulated by phase control into the DC voltage, and
the detector circuit is configured to acquire, as the indication information, information corresponding to an on-period corresponding to the phase control.

4. The ballast system of claim 3, wherein
the detector circuit is configured to acquire, as the information corresponding to the on-period corresponding to the phase control, a phase detection signal, a voltage of which increases as the on-period increases and decreases as the on-period decreases, and
the control circuit is configured to receive, as the indication information, the phase detection signal.

5. The ballast system of claim 1, wherein
each of the constant current circuits comprises a semiconductor switching device connected in series with a corresponding light source module of the light source modules, and is configured to regulate a current flowing through the semiconductor switching device, thereby adjusting a load current flowing through the corresponding light source module, and
the target voltage value is set based on a voltage across a semiconductor switching device of each of the constant current circuits in a transition between a first region and a second region in operational regions of the semiconductor switching device, a ratio of a change in a current flowing through the semiconductor switching device to a change in a voltages across the semiconductor switching device in the first region being larger than that in the second region.

6. The ballast system of claim 1, wherein the control circuit is configured to:
maintain the DC voltage at a predetermined initial voltage value after activation of the control circuit;
choose the target feedback voltage from the feedback voltages; and
control the power supply circuit so that a difference between a value of the target feedback voltage and the target voltage value is reduced,
thereby adjusting the DC voltage.

7. The ballast system of claim 1, wherein
each potential on the signal paths is
first potential which is potential at a junction point of the resistors in a corresponding pull-up circuit of the pull-up circuits when a corresponding constant current circuit of the constant current circuits adjusts, to zero, a load current flowing a corresponding light source module of the light source modules, and also
second potential by a voltage drop across the corresponding constant current circuit when the corresponding constant current circuit does not adjust the load current flowing the corresponding light source module to zero,
each first potential being higher than each second potential.

8. A luminaire, comprising:
a light source including light source modules;
constant current circuits that are connected in series with the light source modules so that the constant current circuits and the light source modules constitute their respective series circuits, the constant current circuits being configured to respectively adjust load currents flowing through the light source modules;
a power supply circuit that has a pair of output terminals between which the series circuits are connected in parallel, the power supply circuit being configured to apply a DC voltage across each of the series circuits through the pair of output terminals;
signal paths that allow feedback voltages corresponding to voltage drops across the constant current circuits to be respectively applied to;
a control circuit that is connected with the signal paths, the control circuit being configured to control the power supply circuit so that a target feedback voltage is maintained at a target voltage value, thereby adjusting the DC voltage, the target feedback voltage being a lowest feedback voltage of the feedback voltages; and
pull-up circuits, each of which includes a first end and a second end as well as resistors, the resistors being connected in series between the first and second ends to constitute a voltage divider that allows a predetermined voltage to be applied across the first and second ends,
a junction point of two resistors of the resistors in each of the pull-up circuits being connected to a corresponding signal path of the signal paths.

9. A lighting system, comprising a series circuit of:
the ballast system of claim 3; and
a dimmer configured to supply the ballast system with the AC voltage regulated by the phase control.

10. A lighting control method, executed by a ballast system of claim 1, wherein the lighting control method comprising steps of:
acquiring the feedback voltages through the signal paths;
choosing, as the target feedback voltage, a lowest feedback voltage from the feedback voltages; and
controlling the power supply circuit so that the power supply circuit adjusts the DC voltage by maintaining the target feedback voltage at the target voltage value.

11. A non-transitory computer readable medium, storing a computer program which, when the computer program is executed by a computer provided for the ballast system of claim 1, causes the computer to carry out steps of:
acquiring the feedback voltages through the signal paths;
choosing, as the target feedback voltage, a lowest feedback voltage from the feedback voltages; and
controlling the power supply circuit so that the power supply circuit adjusts the DC voltage by maintaining the target feedback voltage at the target voltage value.
